(19) United States
(12) Patent Application Publication
(10) Pub. No.: US 2012/0154221 A1
(43) Pub. Date: Jun. 21, 2012

(54) ELECTRICALLY SMALL OCTAVE BANDWIDTH NON-DISPERSIVE UNI-DIRECTIONAL ANTENNA

(76) Inventor: John W. McCORKLE, Vienna, VA (US)

(21) Appl. No.: 13/308,022

(22) Filed: Nov. 30, 2011

Related U.S. Application Data
(60) Provisional application No. 61/425,212, filed on Dec. 20, 2010.

(51) Int. Cl. H01Q 9/04

(52) U.S. Cl. 343/700 MS

(57) ABSTRACT

An electrically small antenna is disclosed that is directional, has over an octave bandwidth, is non-dispersive, is inexpensive to mass produce, and allows transmitter and receiver electronic components to be integrated into the antenna.

### CROSS-REFERENCE TO RELATED APPLICATIONS

This application relies for priority on and claims the benefit of U.S. provisional patent application Ser. No. 61/425,212, entitled “ELECTRICALLY SMALL OCTAVE BANDWIDTH NON-DISPERSIVE UNI-DIRECTIONAL ANTENNA,” which was filed on Dec. 20, 2010, the contents of which are hereby incorporated by reference in their entirety.

### FIELD OF THE INVENTION

The present invention relates generally to antenna apparatuses and systems, and more particularly, to non-dispersive, electrically small wide relative bandwidth antennas.

### BACKGROUND OF THE INVENTION

With respect to the antenna of radar and wide bandwidth communications systems, key antenna characteristics include the size (in wavelengths at the lowest frequency), the beam pattern as a function of frequency, the efficiency versus frequency, the input impedance versus frequency, and the dispersion. Typically, antennas operate with only a few percent bandwidth, where bandwidth is defined to be the −6 dB points of the radiated spectrum. In contrast, many wide bandwidth systems such as radar and digital communications require greater bandwidth and require low dispersion over that bandwidth. For example, as discussed in Lee (U.S. Pat. No. 5,428,364) and McCorkle (U.S. Pat. Nos. 5,880,699, 5,606,331, and 5,523,767), UWB antennas can cover multiple octaves of bandwidth. A discussion of other UWB antennas is found in “Ultra-Wideband Short-Pulse Electromagnetics,” (ed. H. Bertoni, L. Carin, and L. Felsen), Plenum Press New York, 1993 (ISBN 0-306-44530-1).

As recognized by the present inventor, none of the above UWB antennas, however, provide high bandwidth, directional, and non-dispersive characteristics in an electrically small size and in a cost-effective manner. That is, these antennas are expensive to manufacture and mass produce.

A non-dispersive antenna has a transfer function such that the derivative of phase with respect to frequency is a constant (i.e., it does not change versus frequency). In practice, this means that an impulse remains an impulsive waveform, in contrast to a waveform that is spread in time because the phase of its Fourier components are allowed to be arbitrary (even though the power spectrum is maintained), or because the phase-center of the antenna moves physically with frequency. Non-dispersive antennas have particular application in low cost radio and radar systems that require high spatial resolution and cannot afford the costs associated with adding inverse filtering components to mitigate the phase distortion.

Another common problem as presently recognized by the inventor, is that most UWB antennas require balanced (i.e., differential) sources and loads. The balanced feed, results in additional manufacturing costs and reduced performance. For example, baluns raise the cost, attenuate the signal, limit the bandwidth, and often skew the beam pattern of balanced antennas.

Another problem with traditional antennas is that it is difficult to control system ringing. Ringing is caused by energy flowing and bouncing back and forth in the transmission line that connects the antenna to the transmitter or receiver—like an echo. From a practical standpoint, this ringing problem is always present because the antenna impedance, and the transceiver impedance are never perfectly matched with the transmission line impedance. As a result, energy traveling either direction on the transmission line is partially reflected at the ends of the transmission line. The resulting back-and-forth echoes thereby degrade the performance of UWB systems. That is, a clean pulse of received energy that would otherwise be clearly received can be obstructed by the echoes. Ringing is particularly problematic in time domain duplex communication systems and in radar systems because echoes from the high power transmitter can cause long lasting echoes, lasting long enough to cover up the micro-watt signals that must be received nearly immediately after the transmitter finishes sending a burst of energy.

The duration of the ringing is proportional to the product of the length of the transmission line, the reflection coefficient of the antenna, and the reflection coefficient at the transceiver. Therefore, it would be advantageous for the antenna to allow integration of the transmitter and receiver into the antenna so as to minimize the transmission line length. Transmission lines attenuate higher frequencies more than lower frequencies, and sometimes delay higher frequency components more than lower frequency components (i.e. dispersion). Both of these phenomena cause distortion of the pulses flowing through the transmission line. Thus it is clear that techniques that allow shortening of the transmission line have many advantages—reducing loss, ringing, gain-tilt, and dispersion.

### SUMMARY OF THE INVENTION

In view of the foregoing, there exists a need in the art, and accordingly, it is an object of this invention to provide an electrically small, directional, low dispersion, wide bandwidth, low cost antenna that has an unbalanced feed where transmit and or receiving circuits can be integrated onto the same substrate to eliminate transmission line losses, dispersion, and ringing.

It is also an object of this invention to provide a novel apparatus and system for providing an antenna that has a flat frequency response and flat phase response over wide bandwidths.

It is also an object of this invention to provide a novel apparatus and system for providing a UWB antenna that exhibits a symmetric radiation pattern.

It is also an object of this invention to provide a novel apparatus and system for providing a UWB antenna that is efficient, yet electrically small.

It is also an object of this invention to provide a novel apparatus and system for providing a UWB antenna that integrates with the transmitter and receiver circuits on the same substrate.

It is a further object of this invention to provide a novel apparatus and system for providing a directional wide bandwidth antenna that can be arrayed in both 1D and 2D, in which the array of UWB antennas are built on single substrate with the radiation directed in a broadside pattern perpendicular to the plane of the substrate.

These and other objects of the invention are accomplished by providing a planer a set of conductive regions, one being called a driven element, and one being called ground, where these planer regions may also be mounted on a conductive box or conductive “U” shaped chassis. For the purposes of orienting this description, the antenna will be described where the ground region is located on the lower part of the plane containing the conductive regions, and may also extend up the sides and may extend across the top in order to make a connection to any conductive box or chassis. The driven element is typically, but not necessarily, symmetrical about a center vertical line, where the feed point is at the bottom on the centerline. The shape of the driven element is tapered such that its width grows monotonically from the feed point to its maximum width, after which point its width shrinks monotonically to its top. The gap between the driven element region and the ground region grows monotonically from the feed point to the point where the width of the driven element is at its maximum.

Components like transmitter and receiver amplifiers and radio frequency (RF) switches can be placed on the conductive ground region and connected to the feed point in order to minimize transmission line losses and minimize reflection ring-down time. Typically, a simple microstrip or coplanar transmission line is routed in the ground plane, where one end connects to the feed point, and the other end connects to a standard RF connector. The transmission can be made with other standard approaches, include running magnet wire over the ground plane region or coaxial cable over the ground plane. If the conductive elements are formed on the top of a printed circuit board (PCB), the microstrip line can be run on the bottom of the PCB, and connect to the feed point through a via. A coplanar-with-ground “microstrip” line can also be cut into the ground region, where another ground-plane region is added on the bottom of the PCB.

The monotonic gap between the driven region and the ground region is tapered to produce an impulse response reflection, as measured on a time domain reflectometer (TDR), that is a wide pulse. The wider the pulse, the better the low-frequency response of the antenna. The flatter the pulse, the wider the bandwidth of the antenna. The gap distance at the feed is chosen to match the desired transmission line impedance. A typical number is 0.020 inches gap on a 0.032 inch thick εᵣ=3.8 PCB material.

With these and other objects, advantages and features of the invention that may become hereinafter apparent, the nature of the invention may be more clearly understood by reference to the following detailed description of the invention, the appended claims and to the several drawings herein.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a drawing of the basic antenna showing a conductive driven region in the center, and a conductive ground region on the bottom and sides, and without a box or a chassis, according to a disclosed embodiment;

FIG. 2 is a detailed drawing of the driven element, according to a disclosed embodiment;

FIGS. 3A, 3B, and 3C depict the reflected step response of various antenna tapers as would be measured by a time domain reflectometer, according to a disclosed embodiment;

FIGS. 4A, 4B, and 4C depict the reflected impulse response of various antenna tapers as would be measured by a time domain reflectometer, according to a disclosed embodiment;

FIG. 5 shows an alternative way of describing the driven element, according to a disclosed embodiment;

FIG. 6 shows an alternative driven element with concave edges in the upper region, according to a disclosed embodiment;

FIG. 7 shows an alternative driven element with straight edges in the upper region, according to a disclosed embodiment;

FIG. 8 shows an alternative driven element with a flat top, according to a disclosed embodiment;

FIG. 9 is a drawing of a version of the antenna with a conductive driven region in the center, and a conductive ground region on the bottom, sides, and top allowing the ground region to make continuous connection to a box or “U” shaped chassis, according to a disclosed embodiment;

FIG. 10 is a drawing showing a box with the planner antenna attached to the back side, according to a disclosed embodiment;

FIG. 11 is a drawing showing a “U” shaped chassis with the planner antenna attached to it, according to a disclosed embodiment;

FIG. 12 is a drawing showing a “U” shaped chassis with the planner antenna attached to it, and with absorbing material attached to the conducting regions of the planner elements, according to a disclosed embodiment;

FIG. 13 is a drawing showing a box with the planner antenna attached to it, and with absorbing material attached to the sides of the box, according to a disclosed embodiment;

FIG. 14 is a plot showing the an isolated and idealized single-cycle waveform radiating directly from the driven element, and a second delayed and inverted single cycle waveform that comes from the back of the chassis or box, and showing how the sum adds constructively to make a larger radiated signal, according to a disclosed embodiment;

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, may be supported with or in integrated circuits (ICs), such as dynamic random access memory (DRAM) devices, static random access memory (SRAM) devices, or the like. In particular, they may be implemented using CMOS transistors. It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs will be limited to the essentials with respect to the principles and concepts used by the exemplary embodiments.

These and other objects of the invention are accomplished by providing a planer a set of conductive regions, one being called a driven element, and one being called ground, where these planer regions may also be mounted on a conductive box or conductive “U” shaped chassis. For the purposes of orienting this description, the antenna will be described where the ground region is located on the lower part of the plane containing the conductive regions, and may also extend up the sides and may extend across the top in order to make a connection to any conductive box or chassis. The driven element is typically, but not necessarily, symmetrical about a center vertical line, where the feed point is at the bottom on the centerline. The shape of the driven element is tapered such that its width grows monotonically from the feed point to its maximum width, after which point its width shrinks monotonically to its top. The gap between the driven element region and the ground region grows monotonically from the feed point to the point where the width of the driven element is at its maximum.

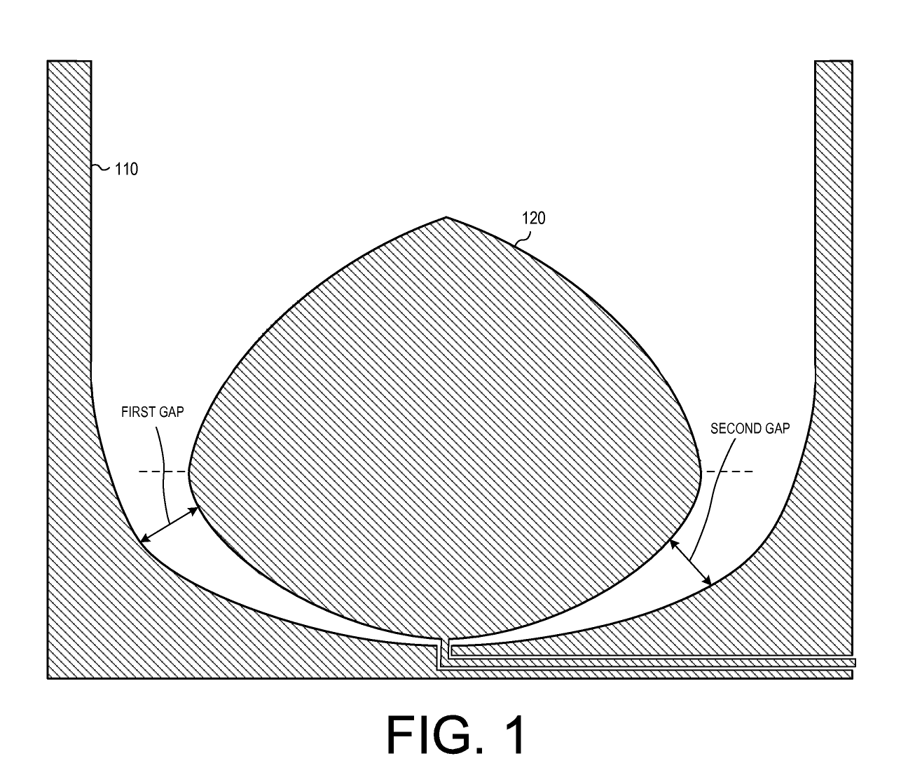

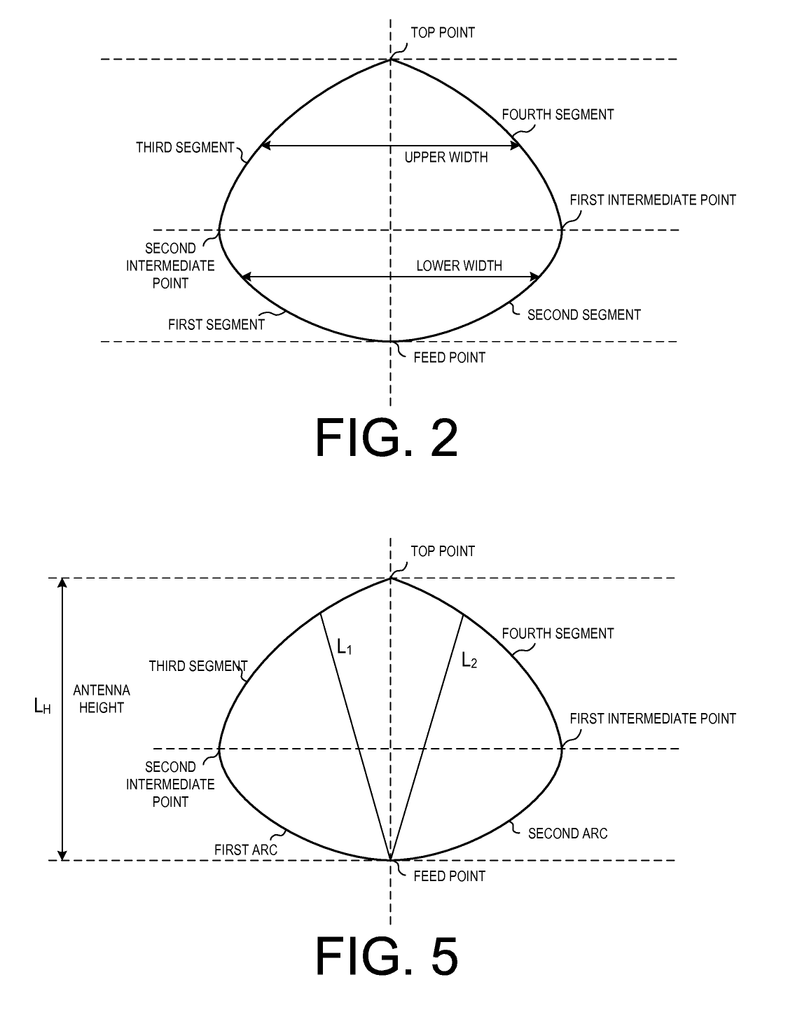

FIG. 1 is a drawing of the basic antenna showing a conductive driven region in the center, and a conductive ground region on the bottom and sides, and without a box or a chassis, according to a disclosed embodiment. The driven element is typically, but not necessarily, symmetrical about a center vertical line, where the feed point is at the bottom on the centerline. The shape of the driven element is tapered such that its width grows monotonically from the feed point to its maximum width, after which point its width shrinks monotonically to its top. FIG. 2 is a detailed drawing of the driven element, according to a disclosed embodiment. It shows one embodiment of the shape of the driven element being tapered such that its width grows monotonically from the feed point to its maximum width, after which point its width shrinks monotonically to its top. FIG. 1 shows the gap between the driven element region and the ground region grows monotonically from the feed point to the point where the width of the driven element is at its maximum.

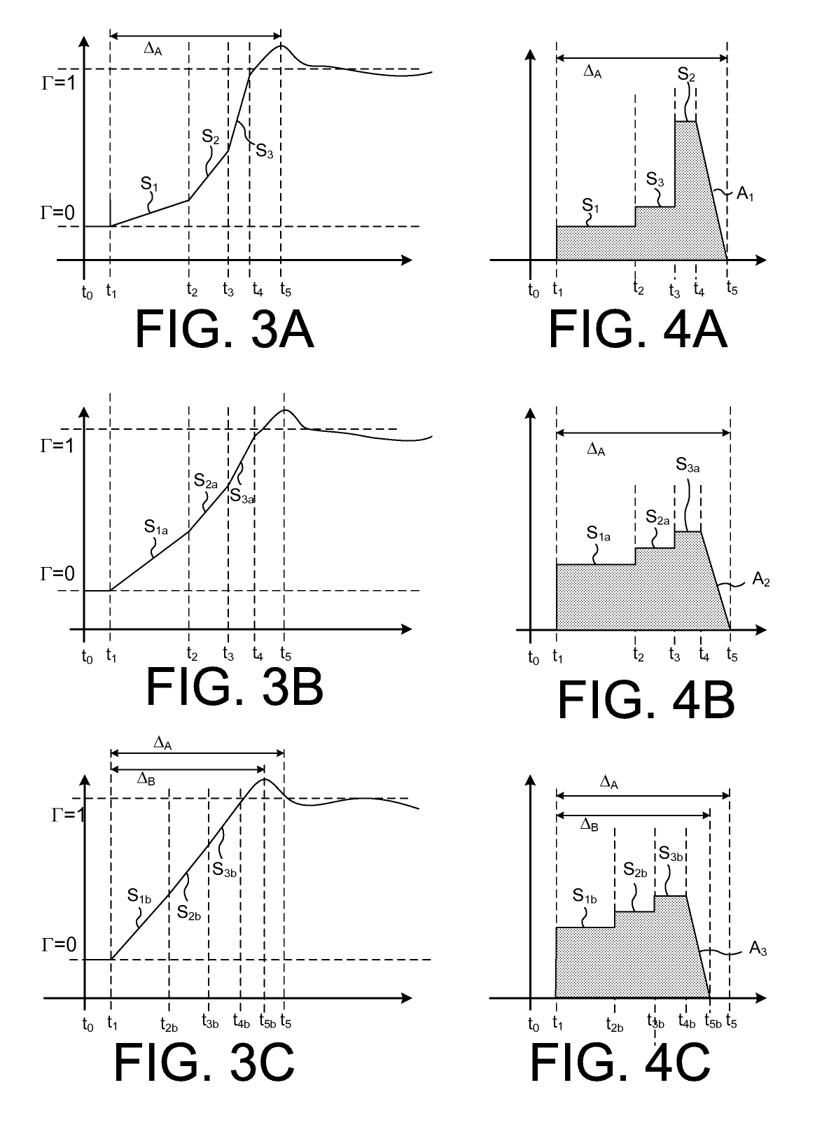

FIGS. 3A, 3B, and 3C and FIGS. 4A, 4B, and 4C are meant to show trends to illustrate how the antenna functions. FIGS. 3A, 3B, and 3C depict the reflected step response of various antenna tapers as would be measured by a time domain reflectometer, according to a disclosed embodiment. FIGS. 4A, 4B, and 4C depict the derivative of the waveforms in 3A, 3B, and 3C, respectively, and therefore depict the reflected impulse response of various antenna tapers as would be measured by a time domain reflectometer, according to a disclosed embodiment. In FIG. 3A, the line starts at a match (e.g. 50 ohms) while the wave propagates down the transmission line to the feed point, at t1. At t1, the reflection coefficient begins sloping upward at a slope that is too slow. The slow slope is caused by the taper in the gap between the lower driven element region and the ground region growing too slowly. In FIG. 3B, the driven element to ground gap taper grows faster than FIG. 3A allowing it to have a steeper slope, between t1 and t2. The steeper slope, means there is less vertical distance to cover between t2 and t4, leading to FIG. 3B having a lower slope than FIG. 3A between t2 and t3 and between t3 and t4. Beyond t2, the slope is governed by both the ground-to-driven-element taper, and the taper in the width of the upper region of the driven element. A simple model of the wave action would be a first wave that propagates around the circumference of the driven element, and a second wave that propagates across the driven element to the top and back to the feed. T2, nominally, represents the time where the second wave comes back to the feed. As such the taper in the width of the driven element defines the slope between t2 and t3.

The low-frequency cutoff of the antenna is governed by the width of the pulse shown in FIGS. 4A, 4B, and 4C, and greater area corresponds to better low frequency radiation and better return loss. A comparison between FIG. 3A and FIG. 4A versus FIG. 3B and FIG. 4B show that the ground-to-driven-element taper in FIG. 3B and FIG. 4B provides better low frequency performance.

FIG. 5 shows an alternative way of describing the driven element, according to a disclosed embodiment. The first and second intermediate points nominally represent where the second wave has had time to come back to the feed.

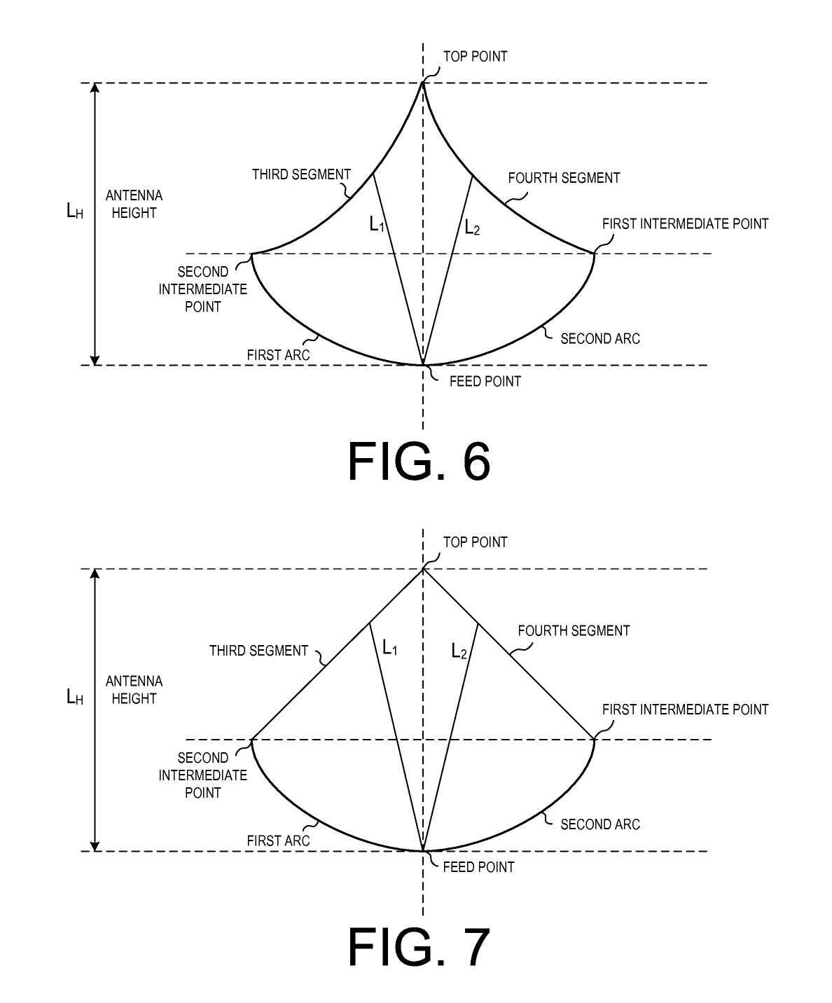

FIG. 6 shows an alternative driven element with concave edges in the upper region, according to a disclosed embodiment.

FIG. 7 shows an alternative driven element with straight edges in the upper region, according to a disclosed embodiment.

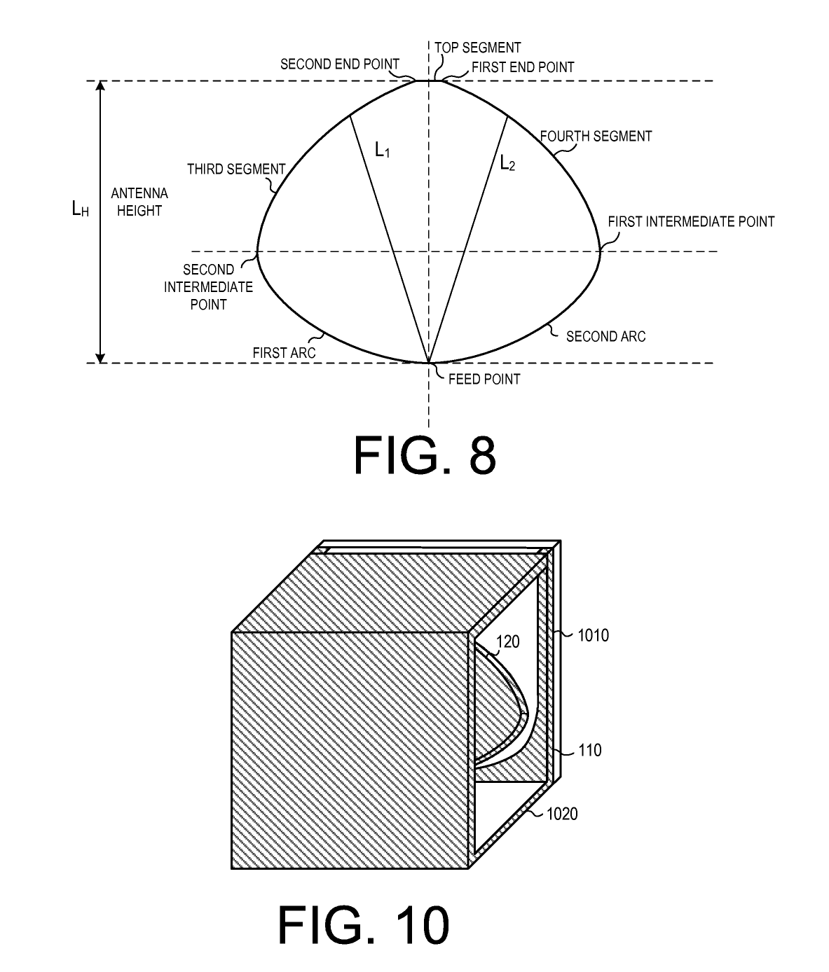

FIG. 8 shows an alternative driven element with a flat top, according to a disclosed embodiment. The shape of the top can be adjusted to obtain more bandwidth by extending the high frequency cutoff at the expense of the low frequency cutoff.

FIG. 9 is a drawing of a version of the antenna with a conductive driven region in the center, and a conductive ground region on the bottom, sides, and top allowing the ground region to make continuous connection to a box or “U” shaped chassis, according to a disclosed embodiment.

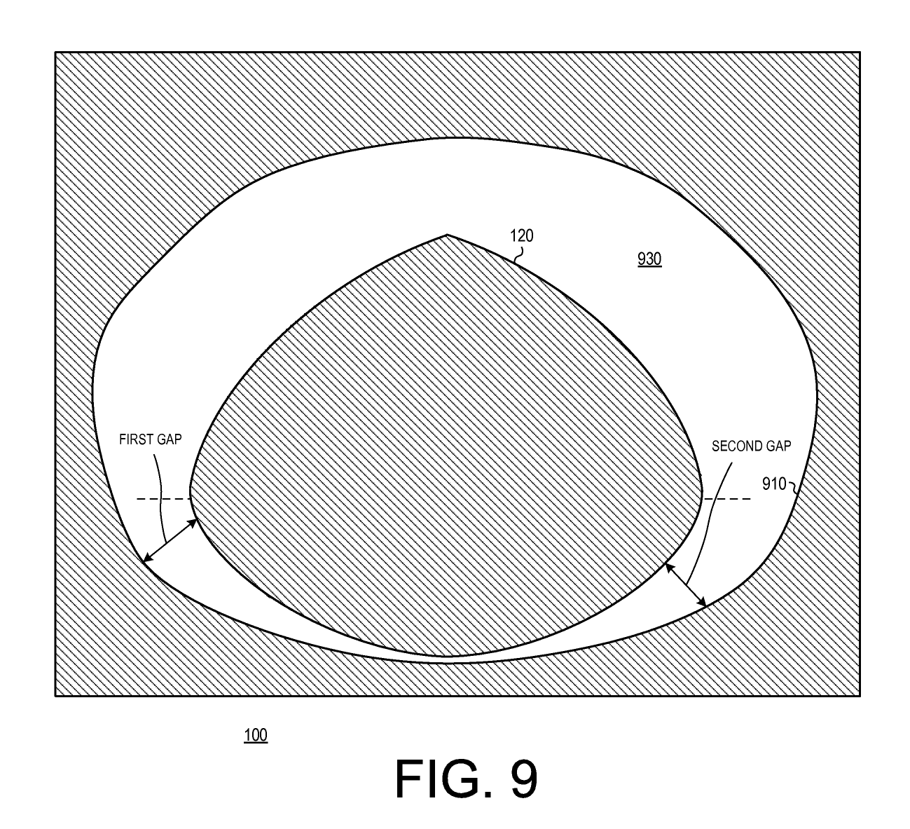

FIG. 10 is a drawing showing a box with the planner antenna attached to the back side, according to a disclosed embodiment;

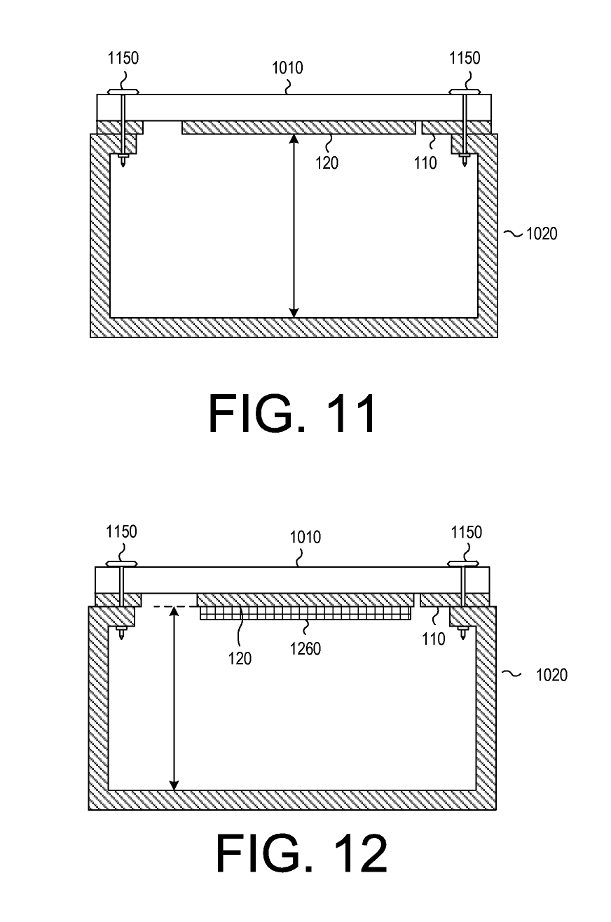

FIG. 11 is a drawing showing a “U” shaped chassis with the planner antenna attached to it, according to a disclosed embodiment;

FIG. 12 is a drawing showing a “U” shaped chassis with the planner antenna attached to it, and with absorbing material attached to the conducting regions of the planner elements, according to a disclosed embodiment;

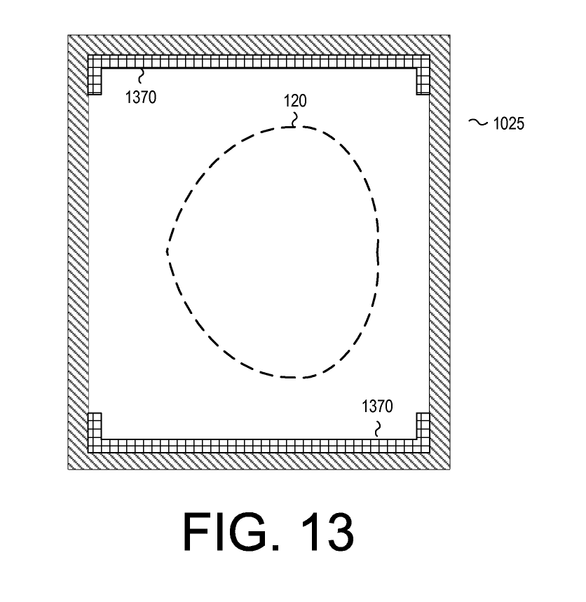

FIG. 13 is a drawing showing a box with the planner antenna attached to it, and with absorbing material attached to the sides of the box, according to a disclosed embodiment;

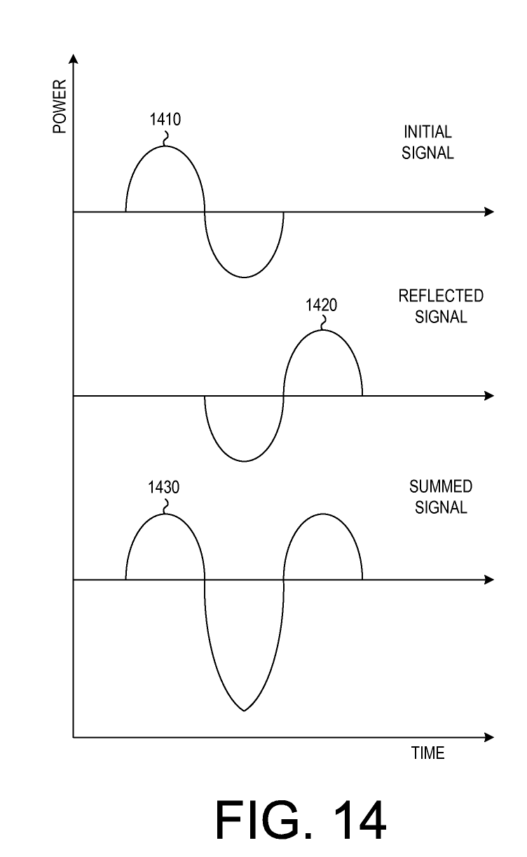

FIG. 14 is a plot showing the an isolated and idealized single-cycle waveform radiating directly from the driven element, and a second delayed and inverted single cycle waveform that comes from the back of the chassis or box, and showing how the sum adds constructively to make a larger radiated signal, according to a disclosed embodiment.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. An antenna, comprising:
a driven element formed of a first conductive material; and
a ground plane formed of a second conductive material,
wherein the active element is defined by:
a first arc extending in a first direction from a feed point to a first intermediate point,
a second arc extending in a second direction from the feed point to a second intermediate point,
a third segment extending from the first intermediate point to the top point,
a fourth segment extending from the second intermediate point to a top point, and
an antenna height between the feed point to the top point,
wherein the antenna height is greater than both a first arc length of the first arc and a second arc length of the second arc,
wherein a first distance between the feed point and the third segment is equal to the first arc length on at least one point along the third segment,
wherein a second distance between the feed point and the fourth segment is equal to the second arc length on at least one point along the fourth segment,
wherein a third distance between the top point and the third segment monotonically decreases for each point along the third segment,
wherein a fourth distance between the top point and the fourth segment monotonically decreases for each point along the fourth segment,
wherein a first gap between the driven element and the ground element increases monotonically between the feed point and the first intermediate point, and
wherein a second gap between the driven element and the ground element increases monotonically between the feed point and the second intermediate point.

2. The antenna of claim 1,
wherein the first and second segments are symmetrical, and
wherein the third and fourth segments are symmetrical.

3. The antenna of claim 1,
wherein the third and fourth segments are arcs.

4. The antenna of claim 1,
wherein the first and second conductive materials are the same.

5. The antenna of claim 1,
wherein the first and second conductive materials are each one of copper or aluminum.

6. An antenna, comprising:
a driven element formed of a first conductive material; and
a ground plane formed of a second conductive material,
wherein the driven element is defined by:
a first segment extending in a first direction from a feed point to a first intermediate point;
a second segment extending in a second direction from the feed point to a second intermediate point;
a third segment extending from the first intermediate point to a top point; and
a fourth segment extending from the second intermediate point to the top point,
wherein a lower width of the driven element between corresponding points on the first and second segments monotonically increases from the feed point to a line intersecting the first and second intermediate points,
wherein an upper width of the driven element between corresponding points on the third and fourth segments monotonically decreases from the line intersecting the first and second intermediate points to the top point,
wherein a first gap between the driven element and the ground element increases monotonically between the feed point and the first intermediate point,
wherein a second gap between the driven element and the ground element increases monotonically between the feed point and the second intermediate point,

7. The antenna of claim 6,
wherein the first and second conductive materials are the same.

8. The antenna of claim 6,
wherein the first and second conductive materials are each one of copper or aluminum.

9. The antenna of claim 6,
wherein the first and second segments are symmetrical, and
wherein the third and fourth segments are symmetrical.

10. An antenna, comprising:
a driven element formed of a first conductive material; and
a ground plane formed of a second conductive material,
wherein the driven element is defined by:
a first segment extending in a first direction from a feed point to a first intermediate point;
a second segment extending in a second direction from the feed point to a second intermediate point;
a third segment extending from the first intermediate point to first end point;
a fourth segment extending from the second intermediate point to a second end point; and
a top segment extending from the first end point to the second end point,
wherein a lower width of the driven element between corresponding points on the first and second segments monotonically increases from the feed point to a line intersecting the first and second intermediate points,
wherein an upper width of the driven element between corresponding points on the third and fourth segments monotonically decreases from the line intersecting the first and second intermediate points to the top segment,
wherein a first gap between the driven element and the ground element increases monotonically between the feed point and the first intermediate point, and
wherein a second gap between the driven element and the ground element increases monotonically between the feed point and the second intermediate point.

11. An antenna, comprising:
a driven element formed of a first conductive material;
a ground plane formed of a second conductive material; and
a U-shaped chassis formed of a third conductive material, the U-shaped chassis contacting the ground plane at an open end, and opposing the driven element,
wherein the driven element is defined by:
a first segment extending in a first direction from a feed point to a first intermediate point;
a second segment extending in a second direction from the feed point to a second intermediate point;
a third segment extending from the first intermediate point to a top point; and
a fourth segment extending from the second intermediate point to the top point,
wherein a lower width of the driven element between corresponding points on the first and second segments monotonically increases from the feed point to a line intersecting the first and second intermediate points,
wherein an upper width of the driven element between corresponding points on the third and fourth segments monotonically decreases from the line intersecting the first and second intermediate points to the top point,
wherein a first gap between the driven element and the ground element increases monotonically between the feed point and the first intermediate point,
wherein a second gap between the driven element and the ground element increases monotonically between the feed point and the second intermediate point,

12. The antenna of claim 11,
wherein the first and second conductive materials are the same.

13. The antenna of claim 11,
wherein the first, second, and third conductive materials are each one of copper, aluminum, tin, or steel.

14. The antenna of claim 11,
wherein the first and second segments are symmetrical, and
wherein the third and fourth segments are symmetrical.

15. The antenna of claim 11,
further comprising a first radio-frequency-absorbing layer formed on the driven element, between the driven element and the U-shaped chassis.

16. The antenna of claim 11,
wherein the first radio-frequency-absorbing layer is smaller than the driven element, but is substantially the same shape as the driven element.

17. An antenna, comprising:
a driven element formed of a first conductive material;
a ground plane formed of a second conductive material; and
a box-shaped chassis formed of a third conductive material, the box-shaped chassis contacting the ground plane at an open end, and opposing the driven element,
wherein the driven element is defined by:
a first segment extending in a first direction from a feed point to a first intermediate point;
a second segment extending in a second direction from the feed point to a second intermediate point;
a third segment extending from the first intermediate point to a top point; and
a fourth segment extending from the second intermediate point to the top point,
wherein a lower width of the driven element between corresponding points on the first and second segments monotonically increases from the feed point to a line intersecting the first and second intermediate points,
wherein an upper width of the driven element between corresponding points on the third and fourth segments monotonically decreases from the line intersecting the first and second intermediate points to the top point,
wherein a first gap between the driven element and the ground element increases monotonically between the feed point and the first intermediate point,
wherein a second gap between the driven element and the ground element increases monotonically between the feed point and the second intermediate point,

18. The antenna of claim 17,
further comprising a first radio-frequency-absorbing layer formed on the driven element, between the driven element and the box-shaped chassis.

19. The antenna of claim 17,
wherein the first radio-frequency-absorbing layer is smaller than the driven element, but is substantially the same shape as the driven element.

20. The antenna of claim 17,
further comprising one or more second radio-frequency-absorbing layers formed on sides of the box-shaped chassis adjacent to the first and second intermediate points.
